(19) United States
(12) Patent Application Publication
(10) Pub. No.: US 2023/0337706 A1
(43) Pub. Date: Oct. 26, 2023

(54) PLANT-BASED BABY FOOD COMPOSITIONS

(71) Applicant: Nunona Inc., New York, NY (US)

(72) Inventors: Krista Maas, New York, NY (US); Louise Gottsche, Pretoria (ZA)

(21) Appl. No.: 17/724,493

(22) Filed: Apr. 20, 2022

(51) Int. Cl. A23L 19/00; A23L 11/00; A23L 17/60; A23L 33/00

(52) U.S. Cl. CPC A23L 19/09; A23L 11/05; A23L 17/60; A23L 33/40; A23V 2002/00

(57) ABSTRACT

A plant-based baby food composition comprising a macronutrient profile, characterized by ratios of macronutrients relative to each other, that provides the macronutrition of human breast milk across different stages of the child's development. The food composition contains a total amount of protein and a total amount of fat in a ratio of about 1:2.5 to 1:7 by weight, a total amount of protein and a total amount of carbohydrates in a ratio of about 1:5.5 to 1:10 by weight, and a total amount of fat and a total amount of carbohydrates in a ratio of about 1:1 to 1:3 by weight. The food composition comprises a first component comprising one or more nuts, one or more seeds, or both; and a second component comprising one or more fruits, one or more vegetables, or both.

### BACKGROUND

Breast milk is referred to as the gold standard for infant nutrition; as it provides all the macronutrients and micronutrients required for the optimal development of infants until around four to six months of age (Hennet & Borsig, 2016). After 4 to 6 months, infants require additional energy and nutrition in addition to what they receive from breast milk. Complementary foods are then needed to provide the additional nutritional support (Begin & Aguayo, 2017), as well as to facilitate the discovery of new flavors and textures and the development of oral skills to drink and chew. Still, the macronutrient profile of breast milk remains the guideline for infant and toddler feeding up until age 2 (Hennet & Borsig, 2016; WHO, 2021) as the infant transitions onto solid foods. The macronutrient composition of mature human breastmilk comprises protein in a total amount of about 0.9 g to 1.2 g per 100 ml, fat in a total amount of about 3.2 g to 3.6 g per 100 ml, and carbohydrate in a total amount of about 6.7 g to 7.8 g per 100 ml (Ballard & Morrow, 2013). Further, breast milk contains about 87%-88% water; the remaining 12%-13% comprise solids, including about 7% (60-70 g/L) carbohydrates, 1% (8-10 g/L) protein, and 3.8% (35-40 g/L) fat. Mature human milk contains 65-70 kcal per 100 mL, and about 50% of the total calorie supply is fat, 40% is carbohydrate, and the remainder is from protein (Kim & Yi, 2020).

Maintaining the correct balance of macronutrients is important when solid foods are introduced. During this complementary food period, adequate nutrient intake is required as infants and toddlers have a high susceptibility for nutrient deficiencies and excesses that may impact health outcomes in early and later life (Koletzko et al., 2016). For instance, protein malnutrition during early childhood can cause damage to some human tissues such as the brain, immune system, and intestinal mucosa, but excessive intake seems to be related to the risk of obesity and associated diseases (Hörnell et al., 2013; Koletzko el al., 2016). As another example, fat is required for brain growth and cognitive development (Savarino el al. , 2021). And low omega 3 fatty acids intake has negative effects on cognitive development (Goyal et at, 2018) and may influence immune functions (Gutiérrez et at, 2019).

The ingredients used in the complementary food can also be impactful on the infant's heath. For instance, complementary food that includes cow's milk is generally not recommended during the first year of life, because high intake of cow's milk during this period can increase the risk of iron deficiency anemia, as well as provide an excess of protein, fat, and energy that can lead to obesity (Fewtrell et a.l, 2017), Sugar should be limited to negate the risk of excessive weight gain (Alvisi et al., 2015). Using ingredients that provide a diversity of flavors and textures can influence the infant's food preferences later in life (Harris & Mason 2017; Maier-loth et al., 2016; Geisel, 1991; Blossfeld et al., 2007). A systematic review concluded that organic food intake is associated with reduced incidence of allergic sensitization, otitis media, metabolic syndrome, high BMI, and non-Hodgkin lymphoma (Vigar et at, 2.020). Further, the introduction of allergenic foods should not be postponed beyond 4-6 months of age, in both high- and low-risk infants. There is no evidence that delaying the introduction of allergenic foods beyond 4 to 6 months prevents atopic disease (Greer et al., 2019). For peanut allergy specifically, it is recommended to introduce peanuts between 4 and 11 months of age to reduce the risk of allergies in high-risk infants (Ferraro et al., 2019).

In addition, plant-based diets offer protection against a number of non-communicable diseases such as cardiovascular diseases, obesity, type-2 diabetes, and some types of cancer. These types of diets are high in fiber and phytochemicals, which impact the composition and function of the gut microbiome and in turn affect overall health. Plant-based diets and/or ingredients are more environmentally sustainable than products from animal origin because they use fewer natural resources and produce fewer greenhouse gas emissions (Craig et al., 2021).

However, most complementary foods that are commercially available lack several nutrients and/or consist of one food group. When compared with human milk, complementary foods are often lower in calories and fat, which means that although energy and nutrient requirements increase, infants and toddlers may not receive all the nutrients they need. Infants' and toddlers' stomachs are small and so complementary foods need to be able to provide ample nutrition or risk the child filling up on calories that do not provide the correct balance of energy required.

Thus, there is a need for a complementary food that uses plant-based ingredients, preferably organic plant-based ingredients, and delivers an appropriate macronutrient profile aligned with the macronutrient profile of human milk to infants as they transition onto solids.

### SUMMARY OF THE INVENTION

The present invention relates to plant-based baby food compositions that can be used as complementary food. The nutrition provided by the composition accounts for the change in the macronutrient profile of breast milk across different stages of the child's development, and the amounts of macronutrients relative to each other.

Thus, in one aspect, the present invention is directed to a plant-based food composition comprising a blend of (a) a first component comprising one or more nuts, one or more seeds, or a combination thereof; and (b) a second component comprising one or more fruits, one or more vegetables, or a combination thereof, The composition comprises protein, fat, and carbohydrates, in which: (i) the total amount of protein and the total amount of fat are in a ratio of about 1:2.5 to 1:7 by weight, (ii) the total amount of protein and the total amount of carbohydrates are in a ratio of about 1:5.5 to 1:10 by weight, and (iii) the total amount of fat and the total amount of carbohydrates are in a ratio of about 1:1 to 1:3 by weight.

In some embodiments, the composition comprises a liquid form, in which (i) the total amount of protein is about 0.9 to 1.2 g per 100 ml, (ii) the total amount of fat is about 3.2 to 3.6 g per 100 ml, and (iii) the total amount carbohydrate is about 6.7 to 7.8 g per 100 ml, In certain embodiments, the composition comprises a total caloric content of about 65 to 70 kcal per 100 ml.

In some embodiments, the composition comprises a frozen form. When the composition is subjected to a preparation that results in a prepared liquid form, in which the preparation comprises at least thawing the composition and optionally adding a liquid to the thawed composition, (i) total amount of protein in the prepared liquid form is about 0.9 to 1.2 g per 100 ml, (ii) total amount of fat in the prepared liquid form is about 3.2 to 3.6 g per 100 ml, and (iii) total amount carbohydrate in the prepared liquid form is about 6.7 to 7.8 g per 100 ml. In certain embodiments, total caloric content in the prepared liquid form is about 65 to about 70 kcal per 100 ml.

In some embodiments, the composition comprises a dried form. When the composition is subjected to preparation that results in a prepared liquid form, in which the preparation comprises at least mixing the composition with a liquid, (i) total amount of protein in the prepared liquid form is about 0.9 to 1.2 g per 100 ml, (ii) total amount of fat in the prepared liquid form is about 3.2 to 3.6 g per 100 ml, and (iii) total amount carbohydrate in the prepared liquid form is about 6.7 to 7.8 g per 100 ml. In some embodiments, total caloric content in the prepared liquid form is about 65 to 70 kcal per 100 ml.

In some embodiments, the composition is divided into two or more portions. The portions may comprise a liquid form, a frozen form, or a dried form. When the portions are subjected to preparation to result in a prepared liquid form, in which the preparation comprises at least mixing the two or more portions together and optionally mixing with a liquid, (i) total amount of protein in the prepared liquid form is about 0.9 to 1.2 g per 100 ml, (ii) total amount of fat in the prepared liquid form is about 3.2 to 3.6 g per 100 ml, and (iii) total amount carbohydrate in the prepared liquid form is about 6.7 to 7.8 g per 100 ml. In certain embodiments, total caloric content in the prepared liquid form is about 65 to 70 kcal per 100 ml.

In other embodiments, the composition comprises a solid form.

In some embodiments, the one or more nuts is selected from peanut, tree nut, or a combination thereof. In some embodiments, the one or more seeds is selected from chia seeds, cacao, flaxseeds, hemp seeds, sesame seeds, pumpkin seeds, and sunflower seeds, and any combination thereof. In certain embodiments, the one or more seeds comprises chia seeds.

In some embodiments, the first component is in an amount sufficient to provide about 2% to 90% of the total protein content of the composition, or is in an amount sufficient to provide about 5% to 75% of the total protein content of the composition. In some embodiments, the first component is in an amount sufficient to provide about 2% to 98% of the total fat content of the composition, or is in an amount sufficient to provide about 3% to 97% of the total fat content of the composition. In some embodiments, the first component is in an amount sufficient to provide about 0.5% to 25% of the total carbohydrate content of the composition, or is in an amount sufficient to provide about 2% to 20% of the total carbohydrate content of the composition. In some embodiments, the first component is in an amount sufficient to provide about 0.5% to 70% of the total caloric content of the composition, or is in an amount sufficient to provide about 1% to 60% of the total caloric content of the composition.

In some embodiments, the first component comprises one or more nuts only. In other embodiments, the first component comprises one or more seeds only. In yet other embodiments, the first component comprises both one or more nuts and one or more seeds.

In some embodiments, the one or more fruits comprises one or more simple fruits, one or more aggregate fruits, one or more multiple fruits, or a combination thereof In certain embodiments, the one or more fruits comprises one or more fruits selected from avocado, banana, date, grape, tomato, guava, blueberry, gooseberry, peach, cranberry, lazone, eggplant, orange, tangerine, lemon, lime, grapefruit, bergamot, clementine, kumquat, pomelo, yuzu, cucumber, pumpkin, squash, muskmelon, watermelon, honeydew, cantaloupe, peach, plum, coconut, mango, pear, apple, quince, rowan, whitebeam, strawberry, blackberry, raspberry, pineapple, fig, mulberry, and any combination thereof

In some embodiments, the one or more vegetables comprises one or more bulb vegetables, one or more flower vegetables, one or more leaf vegetables, one or more root vegetables, one or more seed vegetables, one or more stem vegetables, one or more tuber vegetables, or a combination thereof. In certain embodiments, the one or more vegetables comprises one or more vegetables selected from fennel, garlic, leek, onion, shallot, artichoke, cauliflower, broccoli, bok choy, brussel sprouts, cabbage, lettuce, radicchio, silverbeet, sorrel, spinach, watercress, beetroot, carrot, celeriac, daikon, parsnip, radish, swede, turnip, red kidney bean, soybean, lima bean, cannellini bean, chickpea, lentil, broad bean, pea, snow pea, okra, sweet corn, asparagus, rhubarb, celery, Jerusalem artichoke, potato, yam, and any combination thereof. In certain embodiments, the one or more vegetables comprises one or more legumes.

In some embodiments, the second component is in an amount sufficient to provide about 10% to 98% of the total protein content of the composition, or is in an amount sufficient to provide about 15% to 95% of the total protein content of the composition. In some embodiments, the second component is in an amount sufficient to provide about 0.5% to 95% of the total fat content of the composition, or is in an amount sufficient to provide about 1% to 93% of the total fat content of the composition. In some embodiments, the second component is in an amount sufficient to provide about 70% to 99% of the total carbohydrate content of the composition, or is in an amount sufficient to provide about 80% to 98% of the total carbohydrate content of the composition. In some embodiments, the second component is in an amount sufficient to provide about 30% to 98% of the total caloric content of the composition, or is in an amount sufficient to provide about 40% to 95% of the total caloric content of the composition.

In some embodiments, the second component comprises one or more fruits only. In other embodiments, the second component comprises one or more vegetables only. In yet other embodiments, the second component comprises both one or more fruits and one or more vegetables.

In certain embodiments, the composition further comprises algae. The algae may comprise an oil, a powder, or both. In some embodiments, the algae is in an amount sufficient to provide about 0.1% to 20% of the total fat content of the composition, or is in an amount sufficient to provide about 0.5% to 20% of the total caloric content of the composition.

In certain embodiments, the composition further comprises a grain component. The grain component may comprise one or more grains selected from rice, wheat, oat, barley, rye, bulgur, amaranth, millet, quinoa, sorghum, and triticale.

In some embodiments in which the composition is in liquid form, or subjected to a preparation to result in a prepared liquid form, the composition comprises water in an amount of about 20% to 90% by weight, or in an amount of about 55% to 80% by weight.

In some embodiments, the composition does not comprise any ingredients that are made of an animal product or are sourced from an animal.

In some embodiments, the composition comprises whole-foods.

In some embodiments, the composition comprises organic ingredients.

In some embodiments, the composition does not comprise any synthetic ingredients.

In certain embodiments, the composition is in a package selected from a cup, container, carton, pouch, tray, and tablet.

In another aspect, the present invention is directed to a method of delivering a complementary food source to a human subject of about 4 months to about 3 years of age, in which the method comprises orally administering to the human subject the composition of any of the embodiments described herein.

In yet another aspect, the present invention is directed to a method of delivering a food source having the macronutrient profile of human breast milk to a human subject of about 4 months to about 3 years of age, in which the method comprises orally administering to the human subject the composition according to any of the embodiments described herein.

### DETAILED DESCRIPTION OF THE INVENTION

Some of the main aspects of the present invention are summarized in the Summary of Invention. Additional aspects are described in the Detailed Description of the invention, Examples, and Claims sections of this disclosure. The description in each section of this disclosure is intended to be read in conjunction with the other sections. Furthermore, the various embodiments described in each section of this disclosure can be combined in various different ways, and all such combinations are intended to fall within the scope of the present invention.

The practice of the present invention will employ, unless otherwise indicated, conventional techniques of nutrition, formulation science, food chemistry, and pediatrics, which are within the skill of the art.

In order that the present invention can be more readily understood, certain terms are first defined. Additional definitions are set forth throughout the disclosure. Unless defined otherwise, all technical and scientific terms used herein have the same meaning as commonly understood by one of ordinary skill in the art to which this invention is related.

Any headings provided herein are not limitations of the various aspects or embodiments of the invention, which can be had by reference to the specification as a whole. Accordingly, the terms defined immediately below are more fully defined by reference to the specification in its entirety.

All of the references cited in this disclosure are hereby incorporated by reference in their entireties. In addition, any manufacturers' instructions or catalogues for any products cited or mentioned herein are incorporated by reference. Documents incorporated by reference into this text, or any teachings therein, can be used in the practice of the present invention. Documents incorporated by reference into this text are not admitted to be prior art.

### Definitions

The phraseology or terminology in this disclosure is for the purpose of description and not of limitation, such that the terminology or phraseology of the present specification is to be interpreted by the skilled artisan in light of the teachings and guidance.

As used in this specification and the appended claims, the singular forms “a,” “an,” and “the” include plural referents, unless the context clearly dictates otherwise. The terms “a” (or “an”) as well as the terms “one or more” and “at least one” can be used interchangeably,

Furthermore, “and/or” is to be taken as specific disclosure of each of the two specified features or components with or without the other. Thus, the term “and/or” as used in a phrase such as “A and/or B” is intended to include A and B, A or B, A (alone), and B (alone). Likewise, the term “and/or” as used in a phrase such as “A, B, and/or C” is intended to include A, B, and C; A, B, or C; A or B; A or C; B or C; A and B; A and C; B and C; A (alone); B (alone); and C (alone).

Wherever embodiments are described with the language “comprising,” otherwise analogous embodiments described in terms of “consisting of” and/or “consisting essentially of” are included.

Units, prefixes, and symbols are denoted in their Systeme International de Unites (SI) accepted form. Numeric ranges are inclusive of the numbers defining the range, and any individual value provided herein can serve as an endpoint for a range that includes other individual values provided herein. For example, a set of values such as 1, 2, 3, 8, 9, and 10 is also a disclosure of a range of numbers from 1-10, from 1-8, from 3-9, and so forth. Likewise, a disclosed range is a disclosure of each individual value encompassed by the range. For example, a stated range of 5-10 is also a disclosure of 5, 6, 7, 8, 9, and 10.

The term “plant-based” as used herein refers to being primarily composed of components or ingredients that are derived from, made from, or consist of, plants and/or plant-components. In some embodiments, a plant-based composition means that at least about 80% by weight of the composition is derived from, made from, or consist of, plants. In certain embodiments, a plant-based composition means that at least about 81%, or 82%, or 83%, or 84%, or 85%, or 86%, or 87%, or 88% or 89%, or 90%, or 91%, or 92%, or 93%, or 94%, or 95%, or 96%, or 97%, or 98% or 99%, or 100%, by weight of the composition is derived from, made from, or consist of, plants.

The term “whole-food” as used herein refers to a food that only contains components or ingredients that are natural, i.e., not artificial or synthetic, and that are minimally processed. Thus, a “whole-food” composition does not contain any components or ingredients that are heavily-processed foods, such as highly-refined grain products (e.g., white rice, white flour), foods containing added sugars or artificial sweeteners (e.g., confectioners' sugar, high fructose corn syrup), and foods containing added fat.

The term “organic” as used herein means produced or involving production without the use of chemical fertilizers, pesticides, or other artificial agents.

The term “synthetic ingredient” refers to an ingredient that is not natural, for example, the ingredient was synthesized or is man-made.

The term “macronutrients” as used herein refers to nutrients that the body needs in larger amounts. The three types of macronutrients are proteins, fats, and carbohydrates. Proteins are composed of amino acids, and allow the body to grow, build and repair tissues and health systems, and protect lean body mass. Types of amino acids include non-essential amino acids, which can be generated by the body; essential amino acids, which are required through diet; and conditionally essential amino acids. Fats are important for storing energy, making certain hormones, absorbing fat soluble vitamins, and helping with cell membrane integrity. The intake of specific fatty acids is essential in the first two years to support brain growth and development. Carbohydrates break down into glucose, which is the main energy source of the body. They are indispensable for the metabolism of erythrocytes and vital organs such as kidney and brain.

The term “macronutrient profile” as used herein refers to the content of macronutrients—proteins, fats, and carbohydrates—in a composition. The content can be expressed as ratios of each macronutrient relative to each other, or as a quantity of macronutrients.

“Complementary food source” refers to a food that is to be administered when a baby can no longer receive all of its nutritional needs through breast milk or formula. Typically, the need for a complementary food source begins at approximately four to six months of age, and continues until the child is about three years old, at which point the child has fully transitioned to solid food.

The term “liquid form” as used herein is a liquid as set forth in the International Dysphagia Diet Standardisation Initiative (IDDSI) Framework (Cicero et al., 2017; which is incorporated herein by reference). Applying the IDDSI Framework, a liquid form may comprise a thickness level ranging from thin (Level 0 under the IDDSI Framework), slightly thick (Level 1), mildly thick (Level 2), moderately thick (Level 3), or extremely thick/pureed (Level 4).

The term “frozen form” as used herein is a form resulting from a thermal processing in which all or generally all water is changed to ice.

The term “dried form” as used herein is a form in which all or generally all moisture has been removed. In some embodiments, the form may comprise a population of particles, such as powder or other granules.

The term “solid form” as used herein is a form comprising a thickness that is greater than a “liquid form” as defined herein (i.e., greater than a Level 4 liquid under the IDDSI Framework).

The term “prepared liquid form” is a liquid form that was formerly a different form, such as a dried form or frozen form, but underwent a preparation to become a liquid form. For example, a prepared liquid form may have formerly been a dried form, but underwent a preparation comprising the addition of a liquid. As another example, a prepared liquid form may have formerly been a frozen form, but underwent a preparation comprising a thawing process and optionally the addition of a liquid.

“Mature human milk” refers to milk produced by lactating women, 14 days postpartum (Kim & Yi, 2020). Some consider human milk to be largely mature by 14 days postpartum, and fully matured by four to six weeks postpartum (Ballard & Morrow, 2013).

The term “infant” refers to a child of an age from newborn to about 12 months.

The term “toddler” refers to a child of age from about 12 months to 3 years.

### Food Compositions

The present invention relates to plant-based baby food compositions that can be a complementary food source for a child's healthy growth and development. In particular, the food compositions are designed to comprise a macronutrient profile, characterized by ratios of macronutrients relative to each other, that provides the macronutrition of human breast milk across different stages of the child's development.

In embodiments of the invention, the food compositions comprises a total amount of protein and a total amount of fat in a ratio of about 1:2.5 to 1:7 by weight, a total amount of protein and a total amount of carbohydrates in a ratio of about 1:5.5 to 1:10 by weight, and a total amount of fat and a total amount of carbohydrates in a ratio of about 1:1 to 1:3 by weight. In some embodiments, the food compositions comprises a total amount of protein and a total amount of fat in a ratio of about 1:2.5 to 1:6.5 by weight, a total amount of protein and a total amount of carbohydrates in a ratio of about 1:5.5 to 1:9 by weight, and a total amount of fat and a total amount of carbohydrates in a ratio of about 1:1 to 1:3 by weight. In certain embodiments, the food compositions comprises a total amount of protein and a total amount of fat in a ratio of about 1:2.5 to 1:5 by weight, a total amount of protein and a total amount of carbohydrates in a ratio of about 1:5.5 to 1:8.5 by weight, and a total amount of fat and a total amount of carbohydrates in a ratio of about 1:1 to 1:2.5 by weight.

The food compositions are plant-based and do not contain cow's milk. In some embodiments, the food composition does not contain any ingredients that are made of an animal product or are sourced from an animal. In some embodiments, the food compositions comprise whole-foods, In certain embodiments, the food compositions comprise organic ingredients. In certain embodiments, the food compositions does not contain synthetic ingredients. Further, the food compositions may advantageously contain peanuts and/or tree nuts, which can reduce the risk of developing a peanut and/or tree nut food allergy.

The food compositions can be used to provide nutritional support to a child, preferably as a complementary food to breast milk or an infant formula.

In embodiments of the invention, the food composition may comprise a liquid form, a frozen form, or a dried form.

In embodiments in which the food composition is in frozen form, before the food composition is consumed/ready for consumption, the composition may be subject to a preparation to result in a prepared liquid form. In some embodiments, the preparation may comprise thawing the food composition. In further embodiments, the preparation may comprise adding a liquid to the thawed food composition.

In embodiments in which the food composition is in a dried form, the food composition may comprise particles, such as granules or powder. Before the food composition is consumed/ready for consumption, the composition may be subject to a preparation to result in a prepared liquid form. In some embodiments, the preparation may comprise adding a liquid to the food composition.

In some embodiments, the food composition is divided into two or more portions, in which each of the portions comprises a liquid form, a frozen form, or a dried form. In these embodiments, the food composition may comprise any combination of liquid forms, frozen forms, or dried forms. Before the food composition is consumed/ready for consumption, the composition may be subject to a preparation to result in a prepared liquid form. In some embodiments, the preparation may comprise mixing each of the two or more portions together. In embodiments in which one or more portions comprise a frozen form, the preparation may further comprise thawing the one or more frozen portions, and optionally adding a liquid to the one or more frozen portions, before mixing. In embodiments in which one or more portions comprise a dried form, the preparation may, further comprise adding a liquid to the one or more dry portions before mixing. In certain embodiments, the preparation may further comprise adding a liquid to the mixture of the two or more portions.

The liquid that may be added to a frozen form of the food composition, frozen portion(s) of the food composition, a dried form of the food composition, dry portion(s) of the food composition, or to the mixture of portions of the food composition, as described herein, may be water or a plant-based liquid, for example, coconut milk, soy milk, almond milk, etc.

In embodiments of the invention, the food composition comprising a liquid form, or the prepared liquid form resulting after the food composition is subjected to a preparation, may comprise protein in a total amount of about 0.9 to 1.2 g per 100 ml, fat in a total amount of about 3.2. to 3.6 g per 100 ml, and carbohydrate in a total amount of about 6.7 to 7.8 g per 100 ml. In some embodiments, the food composition comprising a liquid form, or the prepared liquid form resulting after the food composition is subjected to a preparation, may comprise a total caloric content of about 65 to 70 kcal per 100 ml.

In embodiments of the invention, the food composition may comprise a solid form. Examples of solid forms include, but are not limited to, bars, bite-size nuggets, etc.

The food composition of the present invention may comprise a first component comprising one or more nuts, one or more seeds, or a combination thereof; and a second component comprising one or more fruits, one or more vegetables, or combination thereof.

In embodiments in which the first component comprises one or more nuts, the one or more nuts may be selected from peanut, tree nut, or a combination thereof. Examples of tree nuts include, but are not limited to, almonds, Brazil nuts, cashews, hazelnuts, macadamia nuts, pecans, pistachios, and walnuts. The one or more nuts may be in various forms, for example, whole nuts (e.g., peanuts, walnuts, etc.), oil (e.g., peanut oil, walnut oil, etc.), flour (e.g., peanut flour, cashew flour, etc.), or butter (e.g., peanut butter, almond butter).

In embodiments in which the first component comprises one or more seeds, the one or more seeds may comprise one or more different types of seeds. Examples of seeds include, but are not limited to, chia seeds, cacao, flaxseeds, hemp seeds, sesame seeds, pumpkin seeds, and sunflower seeds. In preferred embodiments, the one or more seeds comprises chia seeds.

The one or more seeds may be in various forms, for example, whole seeds (e.g., chia seeds, flaxseeds, etc.), oil (e.g., sesame oil, sunflower oil, etc.), flour (e.g., hemp flour), butter (e.g., tahini (sesame butter), cacap butter, etc.), or powder (e.g., cacao powder),

In embodiments of the invention, the first component may be in an amount to provide about 2% to 90% of the total protein content of the food composition. In some embodiments, the first component may be in an amount to provide about 2% to 85%, or about 2% to 80%, or about 2% to 75%, or about 5% to 85%, or about 5% to 80%, or about 5% to 75%, or about 10% to 85%, or about 10% to 80%, or about 20% to 85%, or about 20% to 80%, or about 20% to 75%, or about 30% to 75%, or about 40% to 75%, or about 50% to 75%, of the total protein content of the food composition. For instance, the first component may comprise about 2%, or about 5%, or about 7%, or about 10%, or about 12%, or about 15%, or about 17%, or about 20%, or about 22%, or about 25%, or about 27%, or about 30%, or about 32%, or about 35%, or about 37%, or about 40%, or about 42%, or about 45%, or about 47%, or about 50%, or about 52%, or about 55%, or about 57%, or about 60%, or about 62%, or about 65%, or about 67%, or about 70% or about 72%, or about 75%, or about 77%, or about 80%, or about 82%, or about 85%, or about 87%, or about 90%, of the total protein content of the food composition; or any amount in between, such as about 51% of the total protein content of the food composition. These percentages of the total protein content can also serve as endpoints for a range of percentages of the total protein content, for example, about 52% to 57%, about 37% to 65%, etc.

In embodiments of the invention, the first component may be in an amount to provide about 2% to 98% of the total fat content of the food composition. In some embodiments, the first component may be in an amount to provide about 2% to 75%, or about 3% to 97%, or about 3% to 90%, or about 3% to 85%, or about 3% to 80%, or about 3% to 75%, or about 5% to 75%, or about 10% to 80%, or about 20% to 97%, or about 20% to 80%, or about 25% to 75%, or about 30% to 97%, or about 30% to 80%, or about 30% to 75%, or about 35% to 75%, of the total fat content of the food composition. For instance, the first component may comprise about 2%; or about 3%, or about 5%, or about 7%, or about 10%, or about 12%, or about 15%, or about 17%, or about 20%, or about 22%, or about 25%, or about 27%, or about 30%, or about 32%; or about 35%, or about 37%, or about 40% or about 42%, or about 45%, or about 47%, or about 50%, or about 52%, or about 55%, or about 57%, or about 60%, or about 62%, or about 65%, or about 67%, or about 70%, or about 72%, or about 75%, or about 77%, or about 80%, or about 82%, or about 85%, or about 87% or about 90%, or about 92%, or about 95%, or about 97%, or about 98%, of the total fat content of the food composition; or any value in between, such as about 29% or 31% of the total fat content of the food composition. These percentages of the total fat content can also serve as endpoints for a range of percentages of the total fat content, for example, about 29% to 31%, about 22% to 45%, etc.

In embodiments of the invention, the first component may be in an amount to provide about 0.5% to 25% of the total carbohydrate content of the food composition. In some embodiments, the first component may be in an amount to provide about 1% to 25%, or about 1% to 20%, or about 2% to 25%, or about 2% to 20%, or about 2% to 15%, or about 5% to 25%, or about 5% to 20%, or about 5% to 15%, of the total carbohydrate content of the food composition. For instance; the first component may comprise about 0.5%, or about 1%, or about 1.5%, or about 2%, or about 2.5%, or about 3%, or about 3.5%, or about 4%, or about 4.5%, or about 5%, or about 5.5%, or about 6%, or about 6.5%, or about 7%. or about 7.5%, or about 8%, or about 8.5%, or about 9%, or about 9.5%, or about 10%, or about 12%, or about 15%, or about 17%, or about 20%, or about 22%, or about 25%, of the total carbohydrate content of the food composition. These percentages of the total carbohydrate content can also serve as endpoints for a range of percentages of the total carbohydrate content, for example, about 7.5% to 8.5%, about 3% to 22%, etc.

In embodiments of the invention, the first component may be in an amount to provide about 0.5% to 70% of the total caloric content of the food composition. In some embodiments, the first component may be in an amount to provide about 0.5% to 65%, or about 0.5% to 60%, or about 1% to 65%, or about 1% to 60%, or about 1% to 55%, or about 1% to 50%, or about 5% to 65%, or about 5% to 60%, or about 5% to 55%, or about 10% to 55%, or about 15% to 55%, or about 15% to 55%, or about 20% to 55%, or about 20% to 55%, or about 25% to 55%, or about 25% to 50%, of the total caloric content of the food composition. For instance, the first component may comprise about 0.5%, or about 1%, or about 2%, or about 3%, or about 5%, or about 7%, or about 10%, or about 12%, or about 15%, or about 17%, or about 20%, or about 22%, or about 25%, or about 27%, or about 30% or about 32%, or about 35%, or about 37%, or about 40%, or about 42%, or about 45%, or about 47%, or about 50%, or about 52%, or about 55%, or about 57%, or about 60%, or about 62%, or about 65%, or about 67%, or about 70%, of the total caloric content of the food composition; including amounts in between, such as about 24% of the total caloric content of the food composition. These percentages of the total caloric content can also serve as endpoints for a range of percentages of the total caloric content, for example, about 22% to 25%, about 7% to 37%, etc.

In embodiments in which the food composition comprises a liquid form, or after the food composition is subjected to a preparation to result in a prepared liquid form, the first component may comprise about 0.1% to 25% by weight of the food composition. In some embodiments, the first component may comprise about 0.1% to 20%, or about 0.1% to 15%, or about 0.1% to 10%, or about 0.1% to 5%, or about 0.3% to 10%, or about 0.3% to 5%, or about 0.5% to 10%, or about 0.5% to 5%, or about 1% to 5%, by weight of the food composition. For example, the first component may comprise about 0.1%, or about 0.2%, or about 0.3%, or about 0.4%, or about 0.5%, or about 0.6%, or about 0.7%, or about 0.8%, or about 0.9%, or about 1%, or about 1,1%, or about 1.2%, or about 1.3%, or about 1.4%, or about 1.5%, or about 1.6%, or about 1.7%, or about 1.8%, or about 1.9%, or about 2%, or about 2.1%, or about 2.2%, or about 2.3%, or about 2,4%, or about 2.5%, or about 2.6%, or about 2.7%, or about 2.8%, or about 2.9%, about 3%, or about 3.1%, or about 3.2%, or about 3.3%, or about 3.4%, or about 3.5%, or about 3.6%, or about 3.7%, or about 3.8%, or about 3.9%, or about 4%, or about 4.1%, or about 4.2%, or about 4.3%, or about 4.4%, or about 4.5%, or about 4.6%, or about 4.7%, or about 4.8%, or about 4.9%, , or about 5%, or about 7%, or about 10%, or about 12%, or about 1.5%, or about 17%, or about 20%, or about 22%, or about 25%, by weight of the food composition. These percentages by weight can also serve as endpoints for a range of amounts of the nut component in the food composition, for example, about 2.4% to 2.7%, about 1% to 4%, etc.

In some embodiments, the first component comprises one or more nuts only. In other embodiments, the first component comprises one or more seeds only. In yet other embodiments, the first component comprises both one or more nuts and one or more seeds.

In embodiments in which the first component comprises both one or more nuts and one or more seeds, the one or more nuts may be in an amount to provide about 0.5% to 80%, or about 1% to 80%, or about 1% to 75%, or about 7% to or about 2% to 70%, or about 3% to 70%, or about 5% to 70%, or about 5% to 65%, or about 10% to 65%, or about 20% to 65%, or about 30% to 65%, or about 40% to 70%, or about 40% to 65%, or about 45% to 65%, or about 50% to 65%, of the total protein content of the food composition; and the one or more seeds may be in an amount to provide about 0.5% to 70%, or about 1% to 70%, or about 1% to 65%, or about 2% to 60%, or about 5% to 65%, or about 5% to 60%, or about 1% to 50%, or about 1% to 40%, or about 1% to 30%, or about 1% to 20%, or about 1% to 10%, of the total protein content of the food composition. In some embodiments, the one or more nuts may be in an amount to provide about 0.5% to 65%, or about 1% to 65%, or about 1% to 60%, or about 3% to 65%, or about 3% to 60%, or about 10% to 60%, or about 20% to 60%, or about 30% to 60%, or about 30% to 55%, of the total fat content of the food composition; and the one or more seeds may be in an amount to provide about 0.5% to 80%, or about 1% to 80%, or about 1% to 75%, or about 3% to 80%, or about 3% to 75%, or about 3% to 70%, or about 1% to 60%, or about 1% to 50%, or about 1% to 40%, or about 1% to 30%, or about 1% to 10%, of the total fat content of the food composition. In some embodiments, the one or more nuts may be in an amount to provide about 0.1% to 20%, or about 0.1% to 15%, or about 0.1% to 10%, or about 0.5% to 15%, or about 0.5% to 10%, or about 1% to 10%, or about 3% to 15%, or about 3% to 10%, or about 5% to 10%, of the total carbohydrate content of the food composition; and the one or more seeds may be in an amount to provide about 0.1% to 20%, or about 0.1% to 15%, or about 0.5% to 20%, or about 0.5% to 15%, or about 1% to 20%, or about 1% to 15%, or about 1% to 5%, or about 1% to 10%, of the total carbohydrate content of the food composition. In some embodiments, the one or more nuts may be in an amount to provide about 0.5% to 45%, or about 0.5% to 40%, or about 1% to 45%, or about 1% to 40%, or about 1% to 35%, or about 2% to 40%, or about 2% to 35%, or about 5% to 40%, or about 10% to 40%, or about 20% to 40%, or about 20% to 35%, of the total caloric content of the food composition; and the one or more seeds may be in an amount to provide about 0.1% to 55%, or about 0.5% to 50%, or about 0.5%, to 45%, or about 0.5%, or about 0.5% to 40%, or about 0.5% to 30%, or about 0.5% to 20%, or about 0.5% to 15%, or about 0.5% to 10%, or about 1% to 10%, or about 1% to 5%, or about 4% to 45%, of the total caloric content of the food composition. In embodiments in which the food composition comprises a liquid form, or after the food composition is subjected to a preparation to result in a prepared liquid form, the one or more nuts may be in an amount to provide about 0.1% to 15%, or about 0.5% to 15%, or about 0.5% to 10%, or about 1% to 10%, or about 1% to 5%, by weight of the food composition; and the one or more seeds may be in an amount to provide about 0.1% to 15%, or about 0.1% to 10%, or about 0.1% to 5%, or about 0. 1% to 3%, or about 0.1% to 2%, or about 0.3% to 2%, or about 0.3% to 1%, or about 0.5% to 1%, by weight of the food composition.

In embodiments in which the second component comprises one or more fruits, the one or more fruits may be selected from a simple fruit (formed from a single pistil), an aggregate fruit (formed by the development of more than pistil from the same flower), and a multiple (formed by the development of more than one pistils that are from more than one flower). Examples of simple fruit for use in the food composition may include, but are not limited to, banana, date, grape, tomato, guava, blueberry, avocado, gooseberry, peach, cranberry, la.zone, eggplant, orange, tangerine, lemon, lime, grapefruit, bergamot, clementine, kumquat, pomelo, yuzu, cucumber, pumpkin, squash, muskmelon, watermelon, honeydew, cantaloupe, peach, plum, coconut, mango, pear, apple, quince, rowan, and whitebeam. Examples of aggregate fruit for use in the food composition may include, but are not limited to, strawberry, blackberry, and raspberry. Examples of multiple fruit for use in the food composition include, but are not limited to pineapple, fig, and mulberry.

In some embodiments, the second component comprises one or more fruits, in which one of the fruits is banana. In some embodiments, the second component comprises one or more fruits, in which one of the fruits is dates. In some embodiments, the second component comprises one or more fruits, in which one of the fruits is avocado. In certain embodiments, the second component comprises banana, dates, avocado, or any combination thereof.

In certain embodiments, the second component comprises banana, dates, avocado, and raspberries.

In certain embodiments, the second component comprises banana, dates, avocado, and blueberries.

The one or more fruit may be raw or cooked, and may be peeled or not peeled. In some embodiments, the fruit may be in an oil form, for example, an avocado oil.

The one or more fruit may include the seed(s) or may have seed(s) removed. The presence of seeds may depend on the type of fruit, and/or whether the fruit is typically served with or without seed(s) as known in the art. For example, if the fruit is a strawberry or banana, the seeds may be present; if the fruit is an apple or avocado, the seed may be removed.

In embodiments in which the second component comprises one or more vegetables, the one or more vegetables may be selected from a bulb vegetable, flower vegetable, leaf vegetable, root vegetable, seed vegetable, stem vegetable, and tuber vegetable. Examples of bulb vegetables for use in the food composition may include, but are not limited to, fennel, garlic, leek, onion, and shallot. Examples of flower vegetables for use in the food composition may include, but are not limited to, artichoke, cauliflower, and broccoli. Examples of leaf vegetables for use in the food composition may include, but are not limited to, bok choy, brussel sprouts, cabbage, lettuce, radicchio, silverbeet, sorrel, spinach, kale, and watercress. Examples of root vegetables for use in the food composition may include, but are not limited to, beetroot, carrot, celeriac, daikon, parsnip, radish, swede, and turnip. Examples of seed vegetables for use in the food composition may include, but are not limited to, bean (green, French, butter, snake), broad bean, pea, snow pea, okra, and sweet corn. Examples of stem vegetables for use in the food composition may include, but are not limited to, asparagus, rhubarb, and celery. Examples of tuber vegetables for use in the food composition may include, but are not limited to, Jerusalem artichoke, potato, and yam.

In some embodiments, the one of more vegetables may comprise a legume. Examples of legumes include, but are not limited to, beans, soybeans, peas, chickpeas, lentils, lupins, mesquite, carob, tamarind, alfalfa, and clover.

The one or more vegetables may be raw or cooked, and may be peeled or not peeled.

In embodiments of the invention, the second component may be in an amount to provide about 10% to 98% of the total protein content of the food composition. In some embodiments, the second component may be in an amount to provide about 10% to 95%, or about 10% to 90%, or about 10% to 80%, or about 10% to 70% or about 10% to 60%, or about 10% to 50%, or about 15% to 98%, or about 15% to 95%, or about 20% to 98%, or about 20% to 95%, or about 25% to 95%, or about 20% to 90%, or about 20% to 80%, or about 20% to 70%, or about 20% to 60%, or about 20% to 50%, or about 25% to 45%, of the total protein content of the food composition. For instance; the second component may comprise about 10%, or about 12%, or about 15%, or about 17%, or about 20%, or about 22%, or about 25%, or about 27%, or about 30%, or about 32%, or about 35%, or about 37%, or about 40%, or about 42%, or about 45%, or about 47%, or about 50%, or about 52%, or about 55%, or about 57%, or about 60%, about 62%, or about 65%, or about 67%, or about 70%, or about 72%, or about 75%, or about 77%, or about 80%, or about 82%, or about 85%, or about 87%, or about 90%, or about 92%, or about 95%, or about 98%, of the total protein content of the food composition; or any amount in between, such as about 39% of the total protein content of the food composition. These percentages of the total protein content can also serve as endpoints for a range of percentages of the total protein content, for example, about 32% to 39%, about 27% to 42%, etc.

In embodiments of the invention, the second component may be in an amount to provide about 0.5% to 95% of the total fat content of the food composition. In some embodiments, the second component may be in an amount to provide about 1% to 95%, or about 1% to 93%, or about 10% to 95%, or about 15% to 95%, or about 20% to 95%, or about 25% to 95%, or about 25% to 90%, or about 25% to 80%, or about 25% to 70%, or about 25% to 60%; or about 25% to 50%, or about 20% to 40%, or about 25% to 40%, or about 30% to 95%, or about 40% to 95%, or about 50% to 95%, or about 60% to 95%, of the total fat content of the food composition. For instance, the second component may comprise about 0.5%, or about 1%, or about 2%, or about 5%, or about 7%, 10%, or about 12%, or about 15%, or about 17%, or about 20%, or about 22%, or about 25%, or about 27%, or about 30% or about 32%, or about 35%, or about 37%, or about 40%, or about 42%, or about 45%, or about 47%, or about 50%, or about 52%, or about 55%, or about 57%, or about 60% or about 62%, or about 65%, or about 67%, or about 70%, or about 72%, or about 75%, or about 77%, or about 80%, or about 82%, or about 85%, or about 87%, or about 90%; or about 92%, or about 95% or about 98%, of the total fat content of the food composition; or any amount in between, such as 51% or 61% of the total fat content of the food composition. These percentages of the total fat content can also serve as endpoints for a range of percentages of the total fat content, for example, about 52% to 62%, about 50% to 65%, etc.

In embodiments of the invention, the second component may be in an amount to provide about 70% to 99% of the total carbohydrate content of the food composition. In some embodiments, the second component may be in an amount to provide about 75% to 99%, or about 75% to 98%, or about 80% to 98%, or about 75% to 95%, or about 80% to 98%, or about 80% to 95%, or about 80% to 90%, of the total carbohydrate content of the food composition. For instance, the second component may comprise about 70%, or about 72%, or about 75%, or about 77%, or about 80%, or about 82%, or about 85%, or about 87%, or about 90%, or about 92%, or about 95%, or about 97%, or about 99%, of the total carbohydrate content of the food composition; or any value in between, such as about 89% of the total carbohydrate content of the food composition. These percentages of the total carbohydrate content can also serve as endpoints for a range of percentages of the total carbohydrate content, for example, about 87% to 89%, about 72% to 92%, etc.

In embodiments of the invention, the second component may be in an amount to provide about 30% to 98% of the total caloric content of the food composition. In some embodiments, the second component may be in an amount to provide about 30% to 98%, or 35% to 98%, or about 40% to 98%, or about 35% to 95%, or about 40% to 95%, or about 45% to 98%, or about 45% to 95%, or about 50% to 95%, or about 45% to 90%, or about 45% to 85%, or about 45% to 80%, or about 50% to 80%, or about 50% to 75%, of the total caloric content of the food composition. For instance, the second component may comprise about 30% or about 32%, or about 35%, or about 37%, or about 40%, or about 42%, or about 45%, or about 47%, or about 50%, or about 52%, or about 55%. or about 57%, or about 60%, or about 62%, or about 65%, or about 67%, or about 70%, or about 72%, or about 75%, or about 77%, or about 80% or about 82%, or about 85%, or about 87%, or about 90%, or about 92%, or about 95%, or about 98%, of the total caloric content of the food composition; or any amount in between, such as about 63% of the total caloric content of the food composition. These percentages of the total caloric content can also serve as endpoints for a range of percentages of the total caloric content, for example, about 63% to 70%, about 57% to 82%, etc.

In embodiments in which the food composition comprises a liquid form, or after the food composition is subjected to a preparation to result in a prepared liquid form, the second component may comprise about 5% to 55% by weight of the food composition, In some embodiments, the second component may comprise about 5% to 50%, or about 10% to 55%, or about 10% to 50%, or about 15% to 50%, or about 15% to 45%, or about 15% to 40%, or about 20% to 45%, or about 25% to 40%, or about 25% to 35%, or about 30% to 40%, or about 30% to 35%, by weight of the food composition. For example, the second component may comprise about 5%, or about 7%, or about 10%, or about 12%, or about 15%, or about 17%, or about 20% or about 22%, or about 25%, or about 27%, or about 30%, or about 32%, or about 35%, or about 37%, about 40%, or about 42%, or about 45%, or about 47%, or about 50% or about 52%, or about 55%, by weight of the food composition, or any weight percentage in between, such as about 31% by weight of the food composition. These percentages by weight can also serve as endpoints for a range of amounts of fruit and/or vegetable in the food composition, for example, about 31% to 35%, about 27% to 40%, etc.

In some embodiments, the second component comprises one or more fruits only. In other embodiments, the second component comprises one or more vegetables only. In yet other embodiments, the second component comprises both one or more fruits and one or more vegetables.

In embodiments of the invention in which the second component comprises both one or more fruits and one or more vegetables, the one or more fruits may be in an amount to provide about 0.5% to 40%, or about 0.5% to 35%, or about 1% to 40%, or about 1% to 35%, or about 5% to 40%, or about 5% to 35%, or about 10% to 40%, or about 10% to 35%, or about 15% to 40%, or about 20% to 40%, or about 20% to 35%, or about 25% to 35%, of the total protein content of the food composition; and the one or more vegetables may be in an amount to provide about 0.5% to75%, or about 1% to 75%, or about 1% to 70%, or about 1% to 50%, or about 1% to 30%, or about 1% to 10%, or about 10 to 75%, or about 30% to 75%, or about 50% to 75%, of the total protein content of the food composition. In some embodiments, the one or more fruits may be in an amount to provide about 0.5% to 95%, or about 1% to 95%, or about 1% to 90%, or about 1% to 80%, or about 1% to 70%, or about 20% to 95%, or about 25% to 95%, or about 25% to 90%, or about 25% to 80%, or about 25% to 70%, or about 30% to 90%, of the total fat content of the food composition; and the one or more vegetables may be in an amount to provide about 0.1% to 20%, or about 0.1% to 15%, or about 0.1% to 10%, or about 0.5% to 10%, of the total fat content of the food composition. In some embodiments, the one or more fruits may be in an amount to provide about 50% to 98%, or about 55% to 98%, or about 55% to 95%, or about 60% to 95%, or about 60% to 90%, or about 65% to 90%, of the total carbohydrate content of the food composition; and the one or more vegetables may be in an amount to provide about 0.1% to 40%, or about 0.5% to 40%, or about 0.5% to 35%, or about 0.5% to 20%, or about 0.5% to 10%, or about 0.5% to 5%, or about 1% to 35%, or about 1% to 30%, of the total carbohydrate content of the food composition. In some embodiments, the one or more fruits may be in an amount to provide about 30% to 95%, or about 35% to 95%, or about 40% to 90%, or about 45% to 85%, or about 40% to 80%, or about 45% to 80%, or about 50% to 80%, or about 50% to 75%, or about 55% to 75%, of the total caloric content of the food composition; and the one or more vegetables may be in an amount to provide about 0.1% to 45%, or about 0.1% to 40%, or about 0.1% to 35%, or about 0.5% to 35%, or about 0.5% to 30%, or about 0.5% to 25%, or about 1% to 25%, or about 1.5% to 25%, of the total caloric content of the food composition, In embodiments in which the food composition comprises a liquid form, or after the food composition is subjected to a preparation to result in a prepared liquid form, the one or more fruits may be in an amount to provide about 5% to 60%, or about 5% to 50%, or about 5% to 40%, or about 10% to 40%, or about 10% to 35%, or about 15% to 35%, or about 15% to 30%, or about 20% to 35%, or about 20% to 30%, by weight of the food composition; and the one or more vegetables may be in an amount to provide about 0.1% to 30%, or about 0.5% to 30%, or about 0.5% to 25%, or about 0.5% to 20%, or about 1% to 20%, or about 1% to 15%, or about 3% to 15%, by weight of the food composition.

In embodiments of the invention, the food composition may further comprise algae. Algae may be added to the composition in any form, including, but not limited to, a powder or an oil.

In some embodiments, the algae may be in an amount to provide about 0% to 2% of the total protein content of the food composition. In certain embodiments, the algae may be in an amount to provide about 0% to 1.5%, or about 0.5% to 2%, or about 0% to 1.5%, or about 0.5% to 1%, of the total protein content of the food composition. For instance; the algae may comprise about 0%, or about 0.1%, or about 0.2%, or about 0.3%, or about 0.4%, or about 0.5%, or about 0.6%, or about 0.7%, or about 0.8%, or about 0.9%, or about 1%, or about 1.1%, or about 1.2%, or about 1.3%, or about 1.4%, or about 1.5%, or about 1.6%, or about 1.7%, or about 1.8%, or about 1.9%, or about 2%, of the total protein content of the food composition. These percentages of the total protein content can also serve as endpoints for a range of percentages of the total protein content, for example, about 0.3% to 1.8%, about 0.5% to 1.7%, etc.

In some embodiments, the algae may be in an amount to provide about 0.1% to 20% of the total fat content of the food composition. In certain embodiments, the algae may be in an amount to provide about 0.5% to 20%, or about 0.5% to about 15%, or about 1% to 15%, or about 1% to 10%, or about 1% to 5%, of the total fat content of the food composition. For instance, the algae may comprise about 0.1%, or about 0.2%, or about 0.3%, or about 0.4%, or about 0.5%, or about 0.6%, or about 0,7%, or about 0.8%, or about 0.9%, or about 1%, or about 1.1%, or about 1.2%, or about 1.3%, or about 1.4%, or about 1.5%, or about 1.6%, or about 1.7%, or about 1.8%, or about 1.9%, or about 2%, or about 2.1%, or about 2.2%, or about 2.3%, or about 2.4%, or about 2.5%, or about 2.6%, or about 2.7%, or about 2.8%, or about 2.9%, about 3%, or about 3.5%, or about 4%, or about 4.5%, or about 5%, or about 7%, or about 10%, or about 12%, or about 15%, or about 17%, or about 20%, of the total fat content of the food composition, including amounts in between, such as about 13% or about 14% of the total fat content of the food composition. These percentages of the total fat content can also serve as endpoints for a range of percentages of the total fat content, for example, about 1.5% to 14%, about 7% to 17%, etc.

In some embodiments, the algae may be in an amount to provide about 0% to 2% of the total carbohydrate content of the food composition. In certain embodiments, the algae may be in an amount to provide about 0% to 1.5%, or about 0.5% to 2%, or about 0% to 1,5%, or about 0.5% to 1%, of the total carbohydrate content of the food composition. For instance, the algae may comprise about 0%, or about 0.1%, or about 0.2%, or about 0.3%, or about 0.4%, or about 0.5%, or about 0.6%, or about 0.7%, or about 0.8%, or about 0.9%, or about 1%, or about 1.1%, or about 1.2%, or about 1.3%, or about 1.4%, or about 1.5%, or about 1.6%, or about 1.7%, or about 1.8%, or about 19%, or about 2%, of the total carbohydrate content of the food composition. These percentages of the total carbohydrate content can also serve as endpoints for a range of percentages of the total protein content, for example, about 0.3% to 1.8%, about 0.5% to 1.7%, etc.

In some embodiments, the algae may be in an amount to provide about 0.5% to 20% of the total caloric content of the food composition. In certain embodiments, the algae may be in an amount to provide about 0.1% to about 15%, or about 0.1% to 10%, or about 0.5% to 10%, or about 0.5% to 5%, of the total caloric content of the food composition. For instance, the algae may comprise about 0.1%, or about 0.2%, or about 0.3%, or about 0.4%, or about 0.5%, or about 0.6%, or about 0.7%, or about 0.8%, or about 0.9%, or about 1%, or about 1.1%, or about 1.2%, or about 1.3%, or about 1.4%, or about 1.5%, or about 1.6%, or about 1.7%, or about 1.8%, or about 1.9%, or about 2%, or about 2.1%, or about 2.2%, or about 2.3%, or about 2.4%, or about 2.5%, or about 2.6%, or about 2.7%, or about 2.8%, or about 2.9%, about 3%, or about 3.1%, or about 3.2%, or about 3.3%, or about 3.4%, or about 3.5%, or about 3.6%, or about 3.7%, or about 3.8%, or about 3.9%, or about 4%, or about 4.1%, or about 4.2%, or about 4.3%, or about 4.4%, or about 4.5%, or about 4.6%, or about 4.7%, or about 4.8%, or about 4.9%, or about 5%, or about 5.1%, or about 5.2%, or about 5.3%, or about 5.4%, or about 5.5%, or about 5.6%, or about 5.7%. or about 5.8%, or about 5.9%, or about 6%, or about 6.1%, or about 6.2%, or about 6.3%, or about 6.4%, or about 6.5%, or about 6.6%, or about 6.7%, or about 6.8%, or about 6.9%, or about 7%, or about 7.1%, or about 7.2%, or about 7.3%, or about 7,4%, or about 7.5%, or about 7.6%, or about 7.7%, or about 7.8%, or about 7.9%, or about 8%, or about 10%, or about 12%, or about 15%, or about 17%, or about 20%, of the total caloric content of the food composition. These percentages of the total caloric content can also serve as endpoints for a range of percentages of the total caloric; content, for example, about 0.9% to 7.6%, about 7% to 17%, etc.

In embodiments in which the food composition comprises a liquid form, or after the food composition is subjected to a preparation to result in a prepared liquid form, the algae may comprise about 0.01% to 2% by weight of the food composition. In certain embodiments, the algae may comprise about 0.01% to about 1.5%, or about 0.01% to 1%, or about 0.03% to 0.8%, or about 0.05% to 0.5%, by weight of the food composition. For example, the algae may comprise about 0.01%, or about 0.02%, or about 0.03%, or about 0.04%, or about 0.05%, or about 0.06%, or about 0.07%, or about 0.08%, or 0.09%, or about 0.1%, or about 0.11%, or about 0.12%, or about 0.13%, or about 0.14%, or about 0.15%, or about 0.16%, or about 0.17%, or about 0.18%, or about 0.19%, or about 0.2%, or about 0.21%, or about 0.22%, or about 0.23%, or about 0.24%, or about 0.25%, or about 0.26%, or about 0.27%, or about 0.28%, or about 0.29%, or about 0.3%, or about 0,32%, or about 0.35%, or about 0.37%, or about 0.4%, or about 0.32%, or about 0.35%, or about 0.37%, or about 0.40% or about 0.42%, or about 0..45%, or about 0.47%, or about 0.5% or about 0.52%, or about 0.55%, or about 0.57%, or about 0.6% or about 0.62%, or about 0.65%, or about 0.67%, or about 0.7% or about 0.72%, or about 0.75%, or about 0.77%, or about 0.8% or about 0.82%, or about 0.85%, or about 0.87%, or about 0.9%, or about 0.92%, or about 0.95%, or about 0.97%, or about 1%, or about 1.1%, or about 1.21%, or about 1.2%, or about 1.3%, or about 1.4%, or about 1.5%, or about 1.6%, or about 1.7%, or about 1.8%, or about 1.9%, or about 2%, by weight of the food composition. These percentages by weight can also serve as endpoints for a range of amounts of the algae in the food composition, for example, about 0.05% to 0.6%, about 0.04% to 1%, etc.

In embodiments of the invention, the food composition may further comprise one or more grains. Examples of grains include, but are not limited to, rice, wheat, oat, barley, rye, bulgur, amaranth, millet, quinoa, sorghum, and triticale. In embodiments in which the food composition comprises a liquid form, or after the food composition is subjected to a preparation to result in a prepared liquid form, the one or more grains may comprise about 0.5% to 20%, or about 0.5% to 15%, or about 1% to 10%, or about 1% to 5%, or about 5% to 10%, by weight of the composition.

In embodiments in which the food composition comprises a liquid form, or after the food composition is subjected to a preparation to result in a prepared liquid form, water may comprise about 20% to 90% by weight of the food composition. In some embodiments, the water may comprise about 25% to 80%, or about 30% to 80%, or about 35% to 80%, or about 40% to 80%, or about 45% to 80%, or about 50% to 80%, or about 55% to 80%, or about 50% to 75%, or about 55% to 75%, or about 55% to 70%, or about 60% to 70% by weight of the food composition. For example, the water may comprise about, about 50%, or about 52%, or about 55%, or about 57%, or about 60%, or about 62%, or about 65%, or about 67%, or about 70%, or about 72%, or about 75%, or about 77%, or about 80%, by weight of the food composition; or any percent weight in between, such as about 64% or about 66% by weight of the food composition. These percentages by weight can also serve as endpoints for a range of amounts of water in the food composition, for example, about 62% to 66%, etc.

In embodiments of the invention, the composition contains docosahexaenoic acid (DHA) in an amount of about 0.025 to 0.2 g per 100 ml, or about 0.025 to 0.1 g per 100 ml, or about 0.03 to 0.08 g per 100 ml, or about 0.06 to 0.07 g per 100 ml.

### Preparation of the Food Compositions

Aspects of the invention relate to methods of preparing the food composition. In some embodiments, the food composition may be prepared by admixing some or all the components of the composition together, including the nut component, the fruit and/or vegetable component, and the seed component. Each of the components may be raw or cooked when mixed together. In some embodiments, the components may undergo a physical processing before mixing, examples of which include, but are not limited to, chopped into large or small pieces, mashed, pureed, grounded, and grated. The mixture may be blended to varying degrees to achieve different textures. For example, the mixture may be blended to the extent that the food composition is a puree, or may be blended to a lesser extent to result in a food composition that has a grainy texture.

In some embodiments, the mixture may be thermally treated or pasteurized to, for example, reduce bacterial loads. For example, the mixture may be boiled or rapidly heated to about 80 to 100° C., for about seconds to about 5 minutes, The heat treatment may be carried out by steam injection or by heat exchanger. The mixture then may be cooled.

In some embodiments, the mixture may be subject to high pressure processing.

In some embodiments in which the food composition is to be in a dried form, e.g., a powder, the mixture may be transferred to a suitable drying apparatus, such as a spray drier or a freeze drier.

The food composition may be packaged. Examples of types of packages include, but are not limited to, cups, containers, cartons, pouches, trays (e.g., ice cube tray), and tablets. In certain embodiments, during packaging, the food composition may be subjected to processes such a nitrogen flushing to prepare the food composition for safe storage.

### Methods of Using the Food Composition

Aspects of the invention relate to uses of the food compositions.

In one aspect, the invention relates to a method of delivering a complementary food source to a human subject of about 4 months to about 3 years of age, the method comprising orally administering to the human subject the food composition. In another aspect, the invention relates to the food composition of the invention for use in delivering a complementary food source to a human subject of about 4 months to about 3 years of age.

In another aspect, the invention relates to a method of delivering a complementary food source having the macronutrient profile of human breast milk to a human subject of about 4 months to about 3 years of age, the method comprising orally administering to the human subject the food composition. In yet another aspect, the invention relates to the food composition of the invention for use in delivering a complementary food source having the macronutrient profile of human breast milk to a human subject of about 4 months to about 3 years of age.

The food composition may be orally administered on a periodic basis. For example, the food composition may be orally administered up to twice daily, once every day, once every two days, three times per week, two times a week, once a week, or combinations thereof.

In some embodiments, the food composition is orally administered in a liquid form or a prepared liquid form as described herein. Prior to administration, in some embodiments, the food composition may be subject to a preparation as described herein. For example, a food composition comprising a frozen form may be subject to a preparation comprising thawing the food composition, and optionally adding a liquid to the thawed food composition. A food composition comprising a dried form may be subject to a preparation comprising adding a liquid to the food composition. Further, a food composition comprising two or more portions may be subject to a preparation comprising mixing the two or more portions together.

In other embodiments, the food composition is orally administered in solid form,

The food composition may be administered in a predefined amount. The predefined amount may be about 1 to 24 ounces, or about 3 to 12 ounces, preferably about 6 ounces. The predefined amount may be administered in a single feeding session, or in more than one feeding session over a course of a day.

In some embodiments, the food composition is administered to a baby who is about 4 to 36 months of age; or about 4 to 24 months of age, or about 6 to 24 months of age.

### EXAMPLES

Embodiments of the present disclosure can be further defined by reference to the following non-limiting examples. It will be apparent to those skilled in the art that many, modifications, both to materials and methods, can be practiced without departing from the scope of the present disclosure.

### Example 1

This example illustrates a food composition according to embodiments of the invention. The composition was a liquid formulation in which the first component comprises both nuts (in this case, peanut butter) and seeds (in this case, chia seeds), and the second component comprises both fruit (in this case, simple fruit) and vegetables (in this case, leaf vegetable) (see Table 1).

The food composition was prepared by mixing and blending the ingredients of the composition together.

TABLE 1
Ingredients and macronutrient profile of the food composition.

| | | Quantity | Protein | Fat | Carbohydrate | Energy |
|---|---|---|---|---|---|---|
| Ingredient | | (g) | (g) | (g) | (g) | (kcal) |
| First | Peanut butter | 18 | 4.8 | 8.4 | 4.2 | 114 |
| Component | Chia seeds | 5 | 0.8 | 1.5 | 2.1 | 24 |
| Second | Banana, raw | 110 | 0.8 | 0.3 | 26.4 | 108 |
| Component | Dates, medjool | 25 | 0.5 | <0.1 | 18.7 | 69 |
| | Spinach, raw | 30 | 0.9 | 0.2 | 0.8 | 8 |
| | Avocado, raw | 80 | 1.6 | 11.8 | 6.8 | 128 |
| | Avocado oil* | 4 | 0 | 4.0 | 0 | 35 |

| | | | | | |
|---|---|---|---|---|---|
| Algae powder | 0.5 | 0 | 0.5 | 0 | 5 |
| Water | 490 | 0 | 0 | 0 | 0 |
| Total | 762.5 | 9.4 | 26.7 | 59 | 491 |
| Total per 100 ml | | 1.2 | 3.5 | 7.7 | 65 |
| Breastmilk (per 100 ml) | | 0.9 to 1.2 | 3.2 to 3.6 | 6.7 to 7.8 | 65 to 70 |

| | |
|---|---|
| Ratio of protein to fat | 1:2.8 |
| Ratio of protein to carbohydrates | 1:6.3 |
| Ratio of fat to carbohydrates | 1:2.2 |

The percent of total quantity (by weight), total protein, total fat, total carbohydrates, and total energy provided by the ingredients are shown in Table 2.

TABLE 2
Percent of total quantity and of each total
macronutrient provided by each ingredient.

| Ingredient | | Quantity | Protein | Fat | Carbohydrate | Energy |
|---|---|---|---|---|---|---|
| First | Nut | 2.4% | 51.1% | 31.4% | 7.1% | 23% |
| Component | Seed | 0.7% | 8.5% | 5.6% | 3.5% | 5% |
| | Total | 3.1% | 59.6% | 37% | 10.6% | 28% |
| Second | Fruit | 28.7% | 30.8% | 60.4% | 88.0% | 69% |
| Component | Vegetable | 3.9% | 9.6% | 0.7% | 1.4% | 2% |
| | Total | 32.6% | 40.4% | 61.1% | 89.4% | 71% |

| | | | | | |
|---|---|---|---|---|---|
| Algae powder | 0.1% | 0.0% | 1.9% | 0.0% | 1% |
| Water | 64.2% | 0.0% | 0.0% | 0.0% | 0% |
| Total | 100% | 100% | 100% | 100% | 100% |

### Example 2

This example illustrates a food composition according to embodiments of the invention. This composition was a liquid formulation in which the first component comprises seeds (in this case, Chia seeds) only, and the second component comprises both fruit (in this case, simple fruit) and vegetables (in this case, leaf vegetable and legume) (see Table 3).

The food composition was prepared by mixing and blending the ingredients of the composition together.

TABLE 3
Ingredients and macronutrient profile of the food composition.

| | | Quantity | Protein | Fat | Carbohydrate | Energy |
|---|---|---|---|---|---|---|
| Ingredient | | (g) | (g) | (g) | (g) | (kcal) |
| First | Chia seeds | 3 | 0.5 | 0.9 | 1.3 | 15 |
| Component | | | | | | |
| Second | Banana, raw | 60 | 0.4 | 0.2 | 14.4 | 59 |
| Component | Dates, medjool | 24 | 0.4 | <0.1 | 18.0 | 66 |
| | Spinach, raw | 30 | 0.9 | 0.2 | 0.8 | 8 |
| | Chickpeas, boiled | 60 | 5.3 | 1.6 | 16.4 | 98 |
| | Avocado, raw | 80 | 1.6 | 11.8 | 6.8 | 128 |
| | Avocado oil | 11 | 0 | 11 | 0 | 97 |

| | | | | | |
|---|---|---|---|---|---|
| Algae oil | 1.2 | 0 | 1.2 | 0 | 11 |
| Water | 475 | 0 | 0 | 0 | 0 |
| Total | 744.2 | 9.1 | 26.9 | 57.7 | 482 |
| Total per 100 ml | | 1.2 | 3.6 | 7.8 | 65 |
| Breastmilk (per 100 ml) | | 0.9 to 1.2 | 3.2 to 3.6 | 6.7 to 7.8 | 65 to 70 |

| | |
|---|---|
| Ratio of protein to fat | 1:3 |
| Ratio of protein to carbohydrates | 1:6.3 |
| Ratio of fat to carbohydrates | 1:2.1 |

The percent of total quantity (by weight), total protein, total fat, total carbohydrates, and total energy provided by the ingredients are shown in Table 4.

TABLE 4
Percent of total quantity and of each total
macronutrient provided by each ingredient.

| Ingredient | | Quantity | Protein | Fat | Carbohydrate | Energy |
|---|---|---|---|---|---|---|
| First | Nut | 0.0% | 0.0% | 0.0% | 0.0% | 0% |
| Component | Seed | 0.4% | 5.5% | 3.3% | 2.3% | 3% |
| | Total | 0.4% | 5.5% | 3.3% | 2.3% | 3% |
| Second | Fruit | 23.5% | 26.4% | 85.6% | 67.9% | 73% |
| Component | Vegetable | 12.1% | 68.1% | 6.7% | 29.8% | 22% |
| | Total | 35.6% | 94.5% | 92.3% | 97.7% | 95% |

| | | | | | |
|---|---|---|---|---|---|
| Algae powder | 0.2% | 0.0% | 4.4% | 0.0% | 2% |
| Water | 63.8% | 0.0% | 0.0% | 0.0% | 0% |
| Total | 100% | 100% | 100% | 100% | 100% |

### Example 3

This example illustrates a food composition according to embodiments of the invention. This composition was a liquid formulation in which the first component comprises both nuts (in this case, almonds) and a seeds (in this case, Chia seeds), the second component comprises fruit only (in this case, simple fruit) (see Table 5).

The food composition was prepared by mixing and blending the ingredients of the composition together.

TABLE 5
Ingredients and macronutrient profile of the food composition.

| | | Quantity | Protein | Fat | Carbohydrate | Energy |
|---|---|---|---|---|---|---|
| Ingredient | | (g) | (g) | (g) | (g) | (kcal) |
| First | Almond butter | 25 | 5.3 | 13.9 | 4.7 | 154 |
| Component | Chia seeds | 5 | 0.8 | 1.5 | 2.1 | 24 |
| Second | Banana, raw | 70 | 0.5 | 0.2 | 16.8 | 69 |
| Component | Dates, medjool | 19 | 0.3 | <0.1 | 14.2 | 53 |
| | Blueberries, raw | 40 | 0.3 | 0.1 | 5.8 | 23 |
| | Blueberry powder | 7.3 | 0.4 | 0.2 | 6.3 | 28 |
| | Avocado, raw | 40 | 0.8 | 5.9 | 3.4 | 64 |
| | Avocado oil | 2 | 0 | 2.0 | 0 | 18 |

| | | | | | |
|---|---|---|---|---|---|
| Algae oil | 1.15 | 0 | 1.1 | 0 | 10 |
| Water | 475 | 0 | 0 | 0 | 0 |
| Total | 684.5 | 8.4 | 24.9 | 53.3 | 443 |
| Total per 100 ml | | 1.2 | 3.6 | 7.8 | 65 |
| Breastmilk (per 100 ml) | | 0.9 to 1.2 | 3.2 to 3.6 | 6.7 to 7.8 | 65 to 70 |

| | |
|---|---|
| Ratio of protein to fat | 1:3 |
| Ratio of protein to carbohydrates | 1:6.3 |
| Ratio of fat to carbohydrates | 1:2.1 |

The percent of total quantity (by weight), total protein, total fat, total carbohydrates, and total energy provided by the ingredients are shown in Table 6.

TABLE 6
Percent of total quantity and of each total
macronutrient provided by each ingredient.

| Ingredient | | Quantity | Protein | Fat | Carbohydrate | Energy |
|---|---|---|---|---|---|---|
| First | Nut | 3.6% | 63.1% | 55.8% | 8.8% | 35% |
| Component | Seed | 1.0% | 9.5% | 6.0% | 4.0% | 5% |
| | Total | 4.6% | 72.6% | 61.8% | 12.8% | 40% |
| Second | Fruit | 26.0% | 27.4% | 33.8% | 87.2% | 58% |
| Component | Vegetable | 0.0% | 0.0% | 0.0% | 0.0% | 0.0% |
| | Total | 26.0% | 27.4% | 33.8% | 87.2% | 58% |

| | | | | | |
|---|---|---|---|---|---|
| Algae powder | 0.1% | 0.0% | 4.4% | 0.0% | 2% |
| Water | 69.3% | 0.0% | 0.0% | 0.0% | 0% |
| Total | 100% | 100% | 100% | 100% | 100% |

### Example 4

This example illustrates a food composition according to embodiments of the invention. This composition was a liquid formulation in which the first component comprises both nuts (in this case, peanut butter) and seeds (in this case, tahini and Chia seeds), and the second component comprises fruit (in this case, simple fruit and aggregate fruit) only (see Table 7).

The food composition was prepared by mixing and blending the ingredients of the composition together.

TABLE 7
Ingredients and macronutrient profile of the food composition.

| | | Quantity | Protein | Fat | Carbohydrate | Energy |
|---|---|---|---|---|---|---|
| Ingredient | | (g) | (g) | (g) | (g) | (kcal) |
| First | Peanut butter | 2 | 0.5 | 0.9 | 0.5 | 13 |
| Component | Tahini | 27 | 4.7 | 14.3 | 5.8 | 160 |
| | Chia seeds | 5 | 0.8 | 1.5 | 2.1 | 24 |
| | Sesame seed oil | 3 | 0.0 | 3.0 | 0.0 | 27 |
| Second | Banana, raw | 98 | 0.7 | 0.3 | 23.5 | 96 |
| Component | Dates, medjool | 19 | 0.3 | <0.1 | 14.2 | 53 |
| | Raspberries, raw | 70 | 1.2 | 0.5 | 8.3 | 36 |
| | Avocado, raw | 44.5 | 0.9 | 6.5 | 3.8 | 71 |

| | | | | | |
|---|---|---|---|---|---|
| Water | 475 | 0 | 0 | 0.0 | 0 |
| Total | 743.5 | 9.1 | 27.0 | 58.2 | 480 |
| Total per 100 ml | | 1.2 | 3.6 | 7.8 | 65 |
| Breastmilk (per 100 ml) | | 0.9 to 1.2 | 3.2 to 3.6 | 6.7 to 7.8 | 65 to 70 |

| | |
|---|---|
| Ratio of protein to fat | 1:3 |
| Ratio of protein to carbohydrates | 1:6.5 |
| Ratio of fat to carbohydrates | 1:2.2 |

The percent of total quantity (by weight), total protein, total fat, total carbohydrates, and total energy provided by the ingredients are shown in Table 8.

TABLE 8
Percent of total quantity and of each total
macronutrient provided by each ingredient.

| Ingredient | | Quantity | Protein | Fat | Carbohydrate | Energy |
|---|---|---|---|---|---|---|
| First | Nut | 0.3% | 5.5% | 3.3% | 0.8% | 3% |
| Component | Seed | 4.7% | 60.4% | 69.6% | 13.6% | 44% |
| | Total | 5.0% | 65.9% | 72.6% | 14.5% | 47% |
| Second | Fruit | 31.1% | 34.1% | 27.0% | 85.6% | 53% |
| Component | Vegetable | 0.0% | 0.0% | 0.0% | 0.0% | 0.0% |
| | Total | 31.1% | 34.1% | 27.1% | 85.6% | 53% |

| | | | | | |
|---|---|---|---|---|---|
| Water | 63.9% | 0.0% | 0.0% | 0.0% | 0% |
| Total | 100% | 100% | 100% | 100% | 100% |

### Example 5

This example illustrates a food composition according to embodiments of the invention. This composition was a liquid formulation in which the first component comprises both nuts (in this case, peanut butter) and seeds (in this case, cacao butter, cacao powder, and chia seeds), and the second component comprises fruit (in this case, simple fruit) and a vegetable (in this case, a leaf vegetable) (see Table 9).

The food composition was prepared by mixing and blending the ingredients of the composition together.

TABLE 9
Ingredients and macronutrient profile of the food composition.

| | | Quantity | Protein | Fat | Carbohydrate | Energy |
|---|---|---|---|---|---|---|
| Ingredient | | (g) | (g) | (g) | (g) | (kcal) |
| First | Peanut butter | 20 | 5.3 | 9.3 | 4.7 | 127 |
| Component | Cacao butter | 11.5 | 0.0 | 11.5 | 0.0 | 102 |
| | Cacao powder | 5 | 1.0 | 0.7 | 2.9 | 11 |
| | Chia seeds | 2 | 0.3 | 0.6 | 0.8 | 10 |
| Second | Banana, raw | 98 | 0.7 | 0.3 | 23.5 | 96 |
| Component | Dates, medjool | 25 | 0.5 | <0.1 | 18.7 | 69 |
| | Spinach, raw | 10 | 0.3 | 0.1 | 0.3 | 3 |

| | | | | | |
|---|---|---|---|---|---|
| Algae powder | 0.5 | 0.0 | 0.5 | 0.0 | 5 |
| Water | 480 | 0 | 0 | 0.0 | 0 |
| Total | 652 | 8.1 | 23 | 50.9 | 423 |
| Total per 100 ml | | 1.2 | 3.6 | 7.8 | 65 |
| Breastmilk (per 100 ml) | | 0.9 to 1.2 | 3.2 to 3.6 | 6.7 to 7.8 | 65 to 70 |

| | |
|---|---|
| Ratio of protein to fat | 1:3 |
| Ratio of protein to carbohydrates | 1:6.5 |
| Ratio of fat to carbohydrates | 1:2.2 |

The percent of total quantity (by weight), total protein, total fat, total carbohydrates, and total energy provided by the ingredients are shown in Table 10.

TABLE 10
Percent of total quantity and of each total
macronutrient provided by each ingredient.

| Ingredient | | Quantity | Protein | Fat | Carbohydrate | Energy |
|---|---|---|---|---|---|---|
| First | Nut | 3.1% | 65.4% | 40.4% | 9.2% | 30% |
| Component | Seed | 2.8% | 16.1% | 55.7% | 7.3% | 29% |
| | Total | 5.9% | 81.5% | 96.1% | 16.5% | 59% |
| Second | Fruit | 18.9% | 14.8% | 1.3% | 82.9% | 39% |
| Component | Vegetable | 1.5% | 3.7% | 0.4% | 0.6% | 1% |
| | Total | 20.4% | 18.5% | 1.7% | 83.5% | 40% |

| | | | | | |
|---|---|---|---|---|---|
| Algae powder | 0.1% | 0.0% | 2.2% | 0.0% | 1% |
| Water | 73.6% | 0.0% | 0.0% | 0.0% | 0% |
| Total | 100% | 100% | 100% | 100% | 100% |

### REFERENCES

Alvisi P., et al. Recommendations on complementary feeding for healthy, full-term infants. Italian Journal of Pediatrics 41: 36 (2015).

Ballard O. & Morrow A.L. Human milk composition: nutrients and bioactive factors. Pediatric Clinics of North America 60(1): 49-74 (2013).

Bégin F. & Aguayo V. M. First foods: why improving young children's diets matter. Maternal & Child Nutrition 13: e12528 (2017).

Blossfeld I., et al. Texture preferences of 12-month-old infants and role of early experiences. Food Quality and Preference 18: 396-404 (2007).

Cicero J. A. Y., et al. Development of international terminology and definitions for texture-modified foods and thickened fluids used in dysphagia management: the IDDSI framework. Dysphagia 32: 293-314 (2017).

Craig W. J, et al. The safe and effective use of plant-based diets with guidelines for health professionals. Nutrients 13: 4144 (2021).

Ferraro V., et al. Timing of food introduction and the risk of food allergy. Nutrients, 11: 1131 (2019).

Fewtrell M., et al. Complementary feeding: a position paper by the European Society for Paediatric Gastroenterology, Hepatology, and Nutrition (ESPGHAN) Committee on nutrition. Journal of Pediatric Gastroenterology and Nutrition 64: 119-132 (2017).

Geisel E. G. Effect of food texture on the development of chewing of children between six months and two years of age. Developmental Medicine and Child Neurology 3: 69-79 (1991).

Goyal M. S., et al. Brain nutrition: a life span approach. Annual Review of Nutrition 38: 17.1-17.19 (2018).

Greer F. R., et al. The Effects of early nutritional interventions on the development of atopic disease in infants and children: the role of maternal dietary restriction, breastfeeding, hydrolyzed formulas, and timing of introduction of allergenic complementary foods. Pediatrics 143(4): 1-11 (2019)

Gutiérrez S., et al. Effects of Omega-3 Fatty Acids on Immune Cells. International Journal of Molecular Sciences 20: 5028 (2019).

Harris G. & Mason S. Are there sensitive periods for food acceptancy in infancy? Current Nutrition Reports 6: 190-196 (2017).

Hennet T. & Borsig L. Breastfed at Tiffany's. Trends in Biochemical Sciences 41: 508-518 (2016).

Hörnell A., et al. Protein intake from 0 to 18 years of age and its relation to health: a systematic literature review for the 5th Nordic Nutrition Recommendations. Food & Nutrition Research 57 (2013).

Kim S. Y. & Yi D. Y. Components of human breast milk: from macronutrient to microbiome and microRNA. Clinical and Experimental Pediatrics 63: 301-309 (2020).

Koletzko B., et al. High protein intake in young children and increased weight gain and obesity risk. American Journal of Clinical Nutrition 103: 303-304 (2016).

Maier-Noth A., et al. The lasting influences of early food-related variety experience: a longitudinal study of vegetable acceptance from 5 months to 6 years in two populations. PLoS ONE 11: e0151356 (2016).

Savarino G., et al. Macronutrient balance and micronutrient amounts through growth and development. Italian Journal of Pediatrics 47: 109 (2021).

Vigar V., et al. A systematic review of organic versus conventional food consumption: is there a measurable benefit on human health? Nutrients 12: 7 (2020).

WHO, World Health Organization, Infant and young child feeding (2021) (https://www.who.int/news-room/fact-sheets/detail/infant-and-young-child-feeding).

The present invention is further described by the following claims.

1. A plant-based food composition comprising a blend of:
(a) a first component comprising one or more nuts, one or more seeds, or a combination thereof; and
(b) a second component comprising one or more fruits, one or more vegetables, or a combination thereof;
wherein the composition comprises protein, fat, and carbohydrates, wherein:
(i) the total amount of protein and the total amount of fat are in a ratio of about 1:2.5 to 1:7 by weight,
(ii) the total amount of protein and the total amount of carbohydrates are in a ratio of about 1:5.5 to 1:10 by weight, and
(iii) the total amount of fat and the total amount of carbohydrates are in a ratio of about 1:1 to 1:3 by weight.

2. The composition of claim 1, wherein:
(a) the composition comprises a liquid form, and:
(i) the total amount of protein is about 0.9 to 1.2 g per 100 ml,
(ii) the total amount of fat is about 3.2 to 3.6 g per 100 ml, and
(iii) the total amount carbohydrate is about 6.7 to 7.8 g per 100 ml, or
(b) the composition comprises a frozen form, and when the composition is subjected to a preparation that results in a prepared liquid form, said preparation comprising at least thawing the composition and optionally adding a liquid to the thawed composition:
(i) the total amount of protein in the prepared liquid form is about 0.9 to 1.2 g per 100 ml,
(ii) the total amount of fat in the prepared liquid form is about 3.2 to 3.6 g per 100 ml, and
(iii) the total amount carbohydrate in the prepared liquid form is about 6.7 to 7.8 g per 100 ml; or
(c) the composition comprises a dried form, and when the composition is subjected to preparation that results in a prepared liquid form, said preparation comprising at least mixing the composition with a liquid:
(i) the total amount of protein in the prepared liquid form is about 0.9 to 1.2 g per 100 ml,
(ii) the total amount of fat in the prepared liquid form is about 3.2 to 3.6 g per 100 ml, and
(iii) the total amount carbohydrate in the prepared liquid form is about 6.7 to 7.8 g per 100 ml.

3. The composition of claim 2, comprising a total caloric content of about 65 to 70 kcal per 100 ml.

4-7. (canceled)

8. The composition of claim 1, divided into two or more portions, the portions comprising a liquid form, a frozen form, or a dried form, wherein, when the portions are subjected to preparation to result in a prepared liquid form, said preparation comprising at least mixing the two or more portions together and optionally mixing with a liquid:
(i) total amount of protein in the prepared liquid form is about 0.9 to 1.2 g per 100 ml,
(ii) total amount of fat in the prepared liquid form is about 3.2 to 3.6 g per 100 ml, and
(iii) total amount carbohydrate in the prepared liquid form is about 6.7 to 7.8 g per 100 ml

9-10. (canceled)

11. The composition of claim 1, wherein the one or more nuts is selected from peanut, tree nut, or a combination thereof

12. (canceled)

13. The composition of claim 1, wherein the one or more seeds is selected from chia seeds, cacao, flaxseeds, hemp seeds, sesame seeds, pumpkin seeds, and sunflower seeds, and any combination thereof.

14. (canceled)

15. The composition of claim 1, wherein the first component is in an amount sufficient to provide about 2% to 90% of the total protein content of the composition, about 2% to 98% of the total fat content of the composition, about 0.5% to 25% of the total carbohydrate content of the composition, and about 0.5% to 70% of the total caloric content of the composition.

16-25. (canceled)

26. The composition of aclaim 1, wherein the one or more fruits comprises one or more simple fruits, one or more aggregate fruits, one or more multiple fruits, or a combination thereof.

27. (canceled)

28. The composition of claim 1, wherein the one or more vegetables comprises one or more bulb vegetables, one or more flower vegetables, one or more leaf vegetables, one or more root vegetables, one or more seed vegetables, one or more stem vegetables, one or more tuber vegetables, or a combination thereof.

29. (canceled)

30. The composition of claim 1, wherein the one or more vegetables comprises a legume.

31. The composition of claim 1, wherein the second component is in an amount sufficient to provide about 10% to 98% of the total protein content of the composition, about 0.5% to 95% of the total fat content of the composition, about 70% to 99% of the total carbohydrate content of the composition, and about 30% to 98% of the total caloric content of the composition.

32-41. (canceled)

42. The composition of claim 1, further comprising algae.

43-45. (canceled)

46. The composition of claim 1, further comprising a grain component.

47. (canceled)

48. The composition of claim 2, wherein the composition in liquid form, or subjected to a preparation to result in a prepared liquid form, comprises water in an amount of about 20% to 90% by weight.

49. (canceled)

50. The composition of claim 1, wherein the composition does not comprise any ingredients that are made of an animal product or are sourced from an animal.

51. The composition of claim 1, wherein the composition comprises whole-foods.

52. The composition of claim 1, wherein the composition does not comprise synthetic ingredients.

53. The composition of claim 1, wherein the composition comprises organic ingredients.

54. (canceled)

55. A method of delivering a complementary food source to a human subject of about 4 months to about 3 years of age, the method comprising orally administering to the human subject the composition of claim 1.

56. A method of delivering a food source having the macronutrient profile of human breast milk to a human subject of about 4 months to about 3 years of age, the method comprising orally administering to the human subject the composition of claim 1.
